(19) United States
(12) Patent Application Publication
(10) Pub. No.: US 2023/0014662 A1
(43) Pub. Date: Jan. 19, 2023

(54) QUANTUM COMPUTER AND METHOD FOR CONTROLLING SAME, QUANTUM ENTANGLEMENT DETECTING DEVICE AND QUANTUM ENTANGLEMENT DETECTING METHOD, AND MOLECULE IDENTIFYING DEVICE AND MOLECULE IDENTIFYING METHOD

(71) Applicants: OSAKA UNIVERSITY, Osaka (JP); KYUSHU UNIVERSITY, NATIONAL UNIVERSITY CORPORATION, Fukuoka (JP)

(72) Inventors: Masateru TANIGUCHI, Osaka (JP); Tomofumi TADA, Fukuoka (JP)

(21) Appl. No.: 17/786,372

(22) PCT Filed: Dec. 21, 2020
(86) PCT No.: PCT/JP2020/047703

§ 371 Date: Jun. 16, 2022

(30) Foreign Application Priority Data
Dec. 20, 2019 (JP) 2019-230969

(51) Int. Cl. G06N 10/40

(52) U.S. Cl. CPC G06N 10/40

(57) ABSTRACT

Provided is a quantum computer which makes it possible to easily carry out quantum calculation. A quantum computer (10) includes electrodes (20) and (21), a molecule (22) that is entirely or partially provided between the electrodes (20) and (21), and a current sensor 13 that detects a tunneling current which flows between the electrodes (20) and (21) via the molecule (22). The molecule (22) works as a quantum circuit for carrying out quantum calculation.

### TECHNICAL FIELD

The present invention relates to a quantum computer and a method for controlling the same, a quantum entanglement detection device, a quantum entanglement detection method, a molecule identification device, and a molecule identification method.

### BACKGROUND ART

A quantum computer carries out calculation (quantum calculation) with use of superposition of quantum mechanical states. The quantum computer is characterized by a significantly faster calculation speed, as compared with known computers (classical computers).

### CITATION LIST

### Non-Patent Literature

[Non-Patent Literature 1]
T. D. Ladd, F. Jelezko, R. Laflamme, Y. Nakamura, C. Monroe, J. L. O'Brien, Nature, 464, 45 (2010)

[Non-Patent Literature 2]
M. A. Nielsen and I. C. Chuang, Quantum Computation and Quantum Information, Cambridge University Press, Cambridge (2000)

### SUMMARY OF INVENTION

### Technical Problem

Known quantum computers can be broadly classified into (i) a computer which uses, as quantum bits, elementary particles such as electrons and photons, (ii) a computer which uses ions as quantum bits, and (iii) a computer which uses superconducting states as quantum bits. In order to generate such quantum bits to carry out quantum calculation, it is necessary to robustly preserve a quantum state so as not to be subject to environmental disturbances, by using nuclear magnetic resonance, quantum optics, quantum dots, superconducting elements, laser cooling, and the like to keep the quantum bits in a very low temperature state. Thus, known quantum computers are facing scientifically and technologically difficult tasks.

An object of an aspect of the present invention is to provide a quantum computer that can easily carry out quantum calculation.

### Solution to Problem

In order to attain the object, a quantum computer in accordance with an aspect of the present invention includes: a plurality of electrodes; a molecule that is entirely or partially provided between the plurality of electrodes; and a detection unit that detects a tunneling current which flows between the plurality of electrodes via the molecule, the molecule working as a quantum circuit for carrying out quantum calculation.

According to experiments conducted by the inventors of the present invention, as a result of measuring the tunneling current, states of the plurality of conductance levels with differences of several orders of magnitude were observed, as well as a novel intermediate state between the conductance levels was observed. This result has been studied, and it has consequently been found that the intermediate state corresponds to a state in which a plurality of pathways of the tunneling current are superposed, as described later. Therefore, the molecule works as a quantum circuit for carrying out quantum calculation based on the tunneling current. By utilizing the molecule as a quantum circuit, the superconducting state and the like which were necessary for known quantum computers are not required, and consequently, quantum calculation can be easily carried out.

In the quantum computer in accordance with this aspect, it is preferable that a plurality of positions at which electrons of the tunneling current enter the molecule or escape from the molecule are used as a quantum bit array. In this case, it is possible to theoretically identify a quantum circuit constituted by a plurality of quantum gates corresponding to the molecule, based on a structure of the molecule, molecular orbitals (in particular, frontier orbitals), and a molecular orbital rule for quantum tunneling.

Note that a plurality of current levels related to the tunneling current can be used as a quantum bit array.

The quantum computer in accordance with this aspect preferably further includes an encoder that encodes, based on the quantum circuit, time series data of the tunneling current into a quantum bit array. In this case, the encoder can also encode a superposition state of a plurality of quantum bits, depending on a value of the tunneling current.

It is considered that the above superposition state also includes a quantum entanglement state.

In view of this, a quantum entanglement detection device in accordance with another aspect of the present invention includes: a plurality of electrodes; a detection unit that detects a tunneling current which flows between the plurality of electrodes via a molecule or a part of the molecule provided between the plurality of electrodes; and a determination unit that determines that a quantum entanglement state is occurring, in a case where a conductance value based on the tunneling current is at an intermediate level between a high level and a low level.

According to the configuration, a quantum entanglement state can be detected without breaking the quantum entanglement state.

A molecule identification device in accordance with yet another aspect of the present invention includes: a plurality of electrodes; a detection unit that detects a tunneling current which flows between the plurality of electrodes via a molecule or a part of the molecule provided between the plurality of electrodes, the molecule working as a quantum circuit having a plurality of quantum gates; an encoder that encodes time series data of the tunneling current into a quantum bit array; a storage unit that stores information of the plurality of quantum gates for each of a plurality of known molecules; another quantum circuit that carries out quantum calculation with respect to the quantum bit array based on the plurality of quantum gates which have been read out from the storage unit; and an identification unit that identifies, based on a result of the quantum calculation, a molecule or a part of the molecule provided between the plurality of electrodes.

As described above, the molecule works as a quantum circuit for carrying out quantum calculation. Moreover, by identifying quantum bits from pathways of the tunneling current flowing through the molecule, the molecule works as a quantum circuit having a plurality of quantum gates.

Therefore, according to the configuration, it is possible to identify an unknown molecule or a part of the unknown molecule by carrying out quantum calculation with respect to a quantum bit array encoded for the unknown molecule provided between a plurality of electrodes on the basis of a plurality of quantum gates for a known molecule. Since quantum calculation can be carried out extremely quickly, an unknown molecule or a part of the unknown molecule can be quickly identified. Said another quantum circuit can be one that is used in a known quantum computer, or can be a molecule working as a quantum circuit.

A method for controlling a quantum computer in accordance with yet another aspect of the present invention is a method for controlling a quantum computer in which a molecule is entirely or partially provided between a plurality of electrodes and the molecule works as a quantum circuit for carrying out quantum calculation, the method including the steps of: detecting a tunneling current which flows between the plurality of electrodes via the molecule; and encoding into a quantum bit array based on time series data of the tunneling current.

According to the method, it is possible to bring about an effect similar to that of the foregoing quantum computer.

A method for detecting quantum entanglement in accordance with yet another aspect of the present invention includes the steps of: detecting a tunneling current which flows between a plurality of electrodes via a molecule or a part of the molecule provided between the plurality of electrodes; and determining that a quantum entanglement state is occurring, in a case where a conductance value based on the tunneling current is at an intermediate level between a high level and a low level.

According to the method, it is possible to bring about an effect similar to that of the foregoing quantum entanglement detection device.

A method for identifying a molecule in accordance with another aspect of the present invention is a method for identifying a molecule or a part of the molecule provided between a plurality of electrodes, the method including the steps of: detecting a tunneling current which flows between the plurality of electrodes via the molecule or the part of the molecule which works as a quantum circuit having a plurality of quantum gates; encoding time series data of the tunneling current into a quantum bit array; carrying out quantum calculation with respect to the quantum bit array based on the plurality of quantum gates which have been read out from a storage unit storing information of the plurality of quantum gates for each of a plurality of known molecules; and identifying the molecule or the part of the molecule based on a result of the quantum calculation.

According to the method, it is possible to bring about an effect similar to that of the foregoing molecule identification device.

### Advantageous Effects of Invention

According to an aspect of the present invention, it is possible to bring about an effect of providing a quantum computer that can easily carry out quantum calculation.

### BRIEF DESCRIPTION OF DRAWINGS

FIG. 1 is a block diagram illustrating a schematic configuration of a quantum computer in accordance with an embodiment of the present invention.

FIG. 2 is a graph showing a time variation of conductance measured by a conductance measurement unit of the quantum computer.

In FIG. 3, the upper part is a schematic diagram illustrating HOMO and LUMO of an adenine molecule, and the lower part is a graph indicating a transmission function for constructive interference and destructive interference in quantum tunneling.

In FIG. 4, the upper part is a schematic diagram illustrating superposition of tunneling pathways in a single configuration of a molecule between electrodes, and the lower part is a graph indicating a transmission function of the single configuration.

In FIG. 5, the upper part is a schematic diagram illustrating superposition of a plurality of configurations of a molecule between electrodes, and the lower part is a graph indicating a transmission function of the plurality of configurations.

FIG. 6 is a diagram illustrating a quantum circuit constituted by a plurality of quantum gates that corresponds to the adenine molecule in the quantum computer.

FIG. 7 is a diagram illustrating an example of quantum computation in the quantum circuit.

FIG. 8 is a block diagram illustrating a schematic configuration of a quantum entanglement detection device in accordance with another embodiment of the present invention.

FIG. 9 is a block diagram illustrating a schematic configuration of a single molecule sequencer in accordance with another embodiment of the present invention.

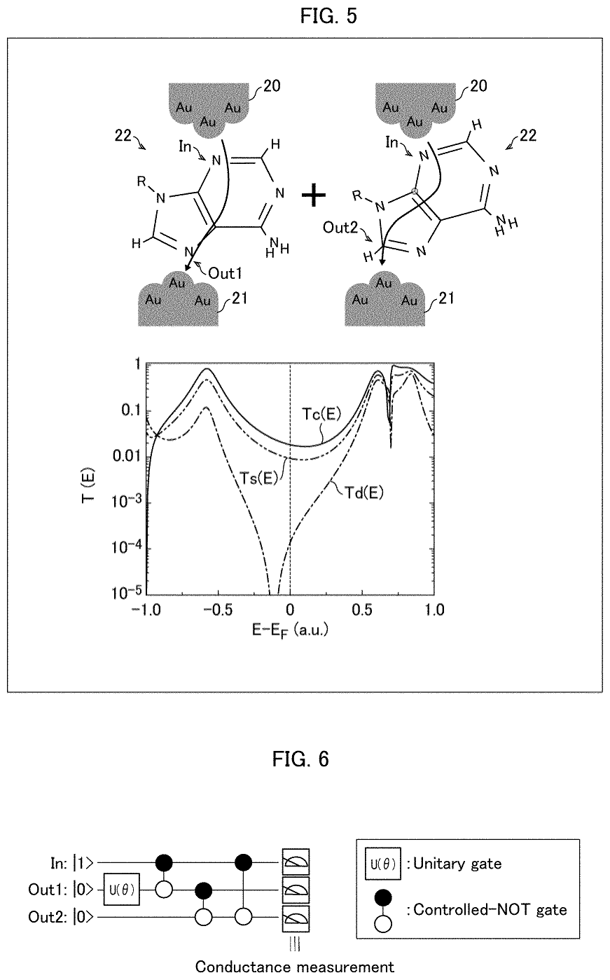

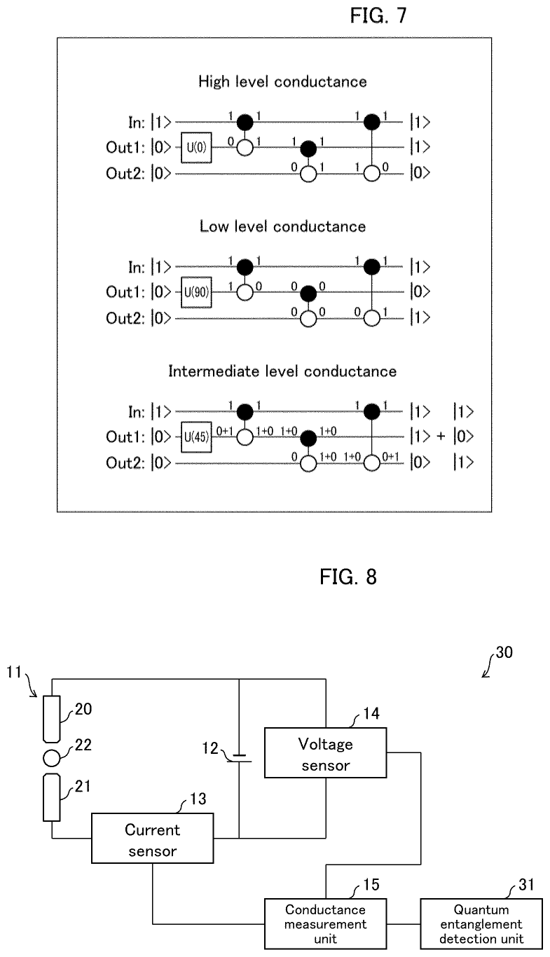

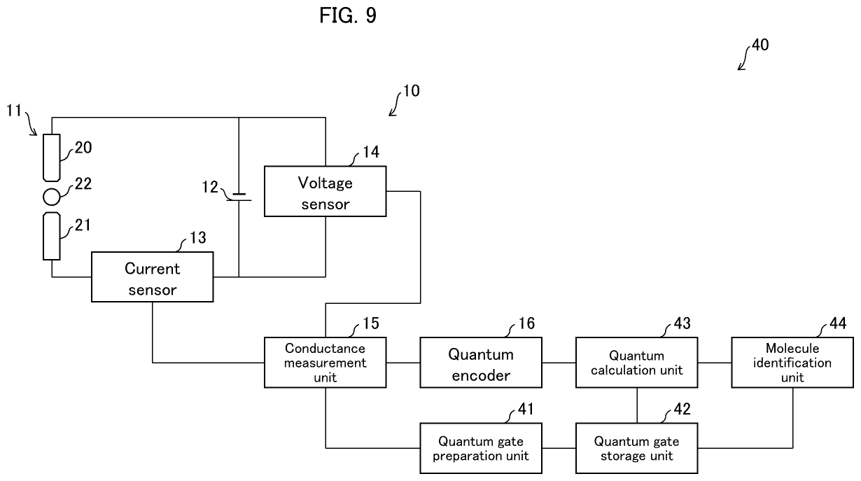

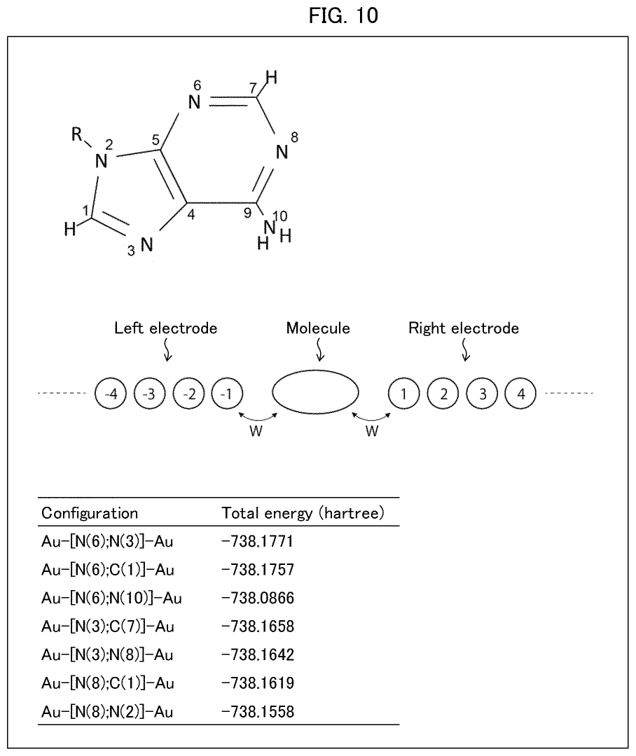

FIG. 10 is a diagram for explaining a theoretical support for discussion related to the phenomenon illustrated in FIG. 2.

### DESCRIPTION OF EMBODIMENTS

The following description will discuss embodiments of the present invention in detail. For convenience of explanation, identical reference numerals are given to constituent members having functions identical with those of the constituent members described in different embodiments, and descriptions of such constituent members are omitted as appropriate.

### Embodiment 1

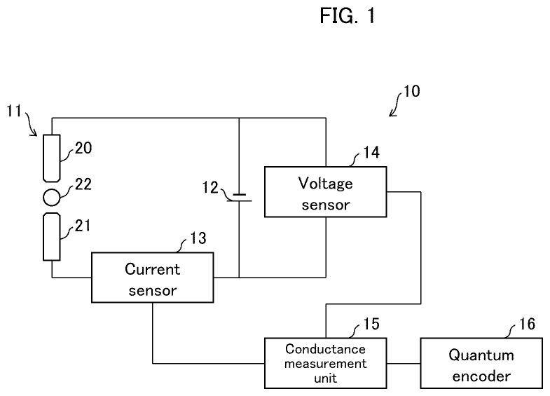

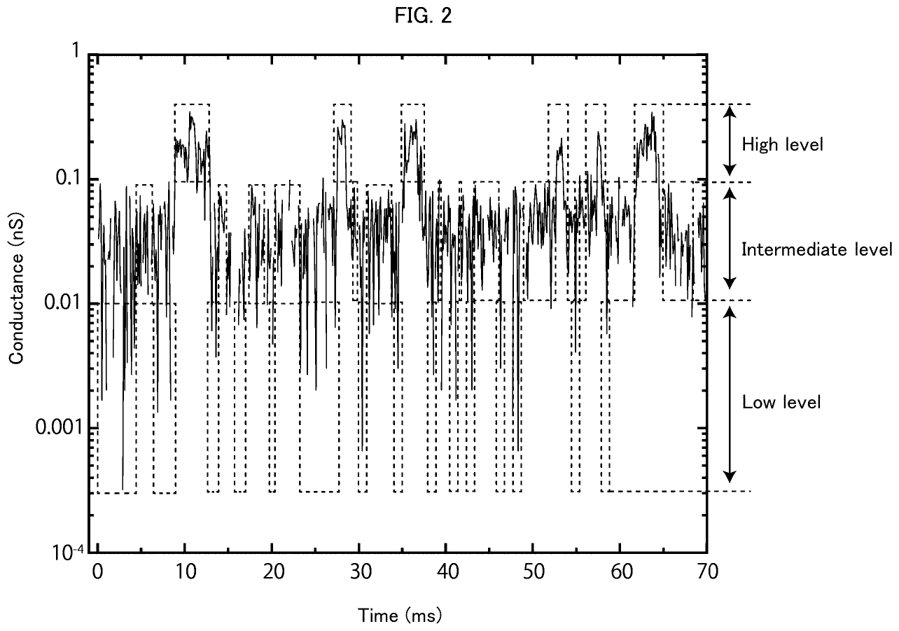

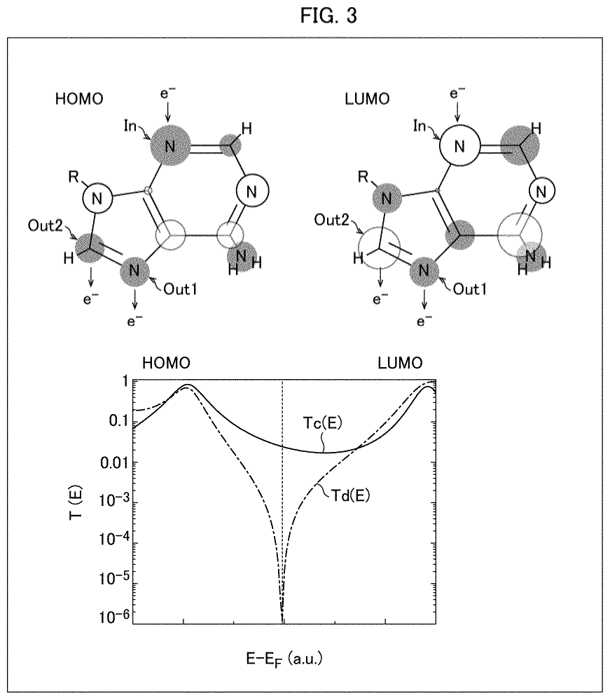

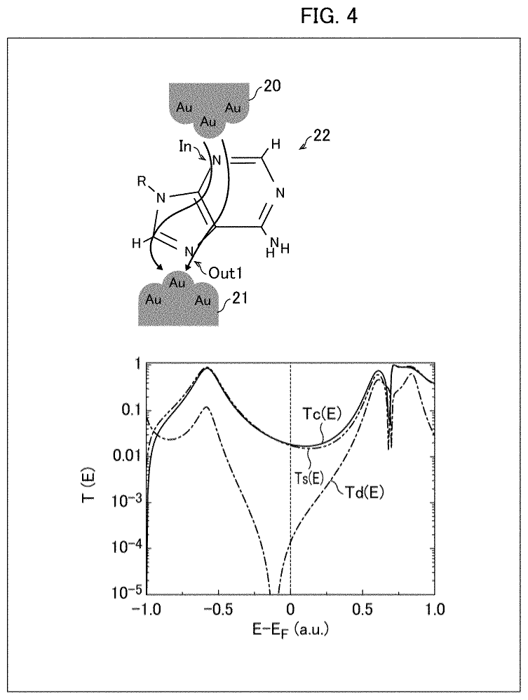

The following description will discuss an embodiment of the present invention with reference to FIGS. 1 through 5.

(Overview of Quantum Computer)

FIG. 1 is a block diagram illustrating a schematic configuration of a quantum computer in accordance with Embodiment 1. As illustrated in FIG. 1, a quantum computer 10 is configured to include a tunneling current generation unit 11, a power source 12, a current sensor 13 (detection unit), a voltage sensor 14, a conductance measurement unit 15, and a quantum encoder 16 (encoder).

The tunneling current generation unit 11 has a configuration in which a single molecule 22 is provided between two electrodes 20 and 21 having a nano-sized space therebetween. By applying an appropriate voltage between the electrodes 20 and 21 by the power source 12, it is possible to generate a tunneling current that flows between the electrodes 20 and 21 via the single molecule 22.

The tunneling current generation unit 11 can be operated at room temperature. It is preferable that the single molecule 22 is a cyclic compound through which a tunneling current flows easily, but the single molecule 22 is not limited to the cyclic compound. Examples of the single molecule 22 include, but are not limited to, aromatic compounds such as benzene, naphthalene, and anthracene, and adenine, thymine, cytosine, and guanine, which are base molecules of deoxyribonucleic acid (DNA), and similar molecules in which terminal structures of those molecules are chemically modified.

The current sensor 13 detects the tunneling current. The voltage sensor 14 detects a voltage between the electrodes 20 and 21. Each of the current sensor 13 and the voltage sensor 14 sends a detected signal to the conductance measurement unit 15.

The conductance measurement unit 15 measures, based on the detected signals from the current sensor 13 and the voltage sensor 14, conductance (electric conductivity) of the single molecule 22 for a tunneling current. The conductance measurement unit 15 sends a measurement value of conductance to the quantum encoder 16. Note that the conductance measurement unit 15 can measure the tunneling current instead of measuring conductance.

FIG. 2 is a graph showing a time variation of conductance measured by the conductance measurement unit 15. In the example of FIG. 2, adenine is used as the single molecule. With reference to FIG. 2, it can be understood that conductance has a large fluctuation between a low level and a high level. It can also be understood that intermediate level conductance appears between the low level conductance and the high level conductance.

As a result of diligent studies on the phenomenon illustrated in FIG. 2, the inventors of the present invention have reached the following conclusion through discussions described later. That is, the single molecule 22 works as a quantum circuit that carries out quantum calculation while using, as quantum bits, positions (sites) in the single molecule 22 at which electrons (tunneling electrons) of a tunneling current enter or escape, and at the intermediate level, a quantum entanglement state by the quantum bits occurs.

Based on this conclusion, the quantum encoder 16 encodes time series data of conductance from the conductance measurement unit 15 into the quantum bit array. The quantum encoder 16 outputs, as a result of the quantum calculation, a set of the encoded quantum bit array and a rotation angle distribution of a unitary gate in a quantum circuit (described later).

(Discussion)

The phenomenon illustrated in FIG. 2 will be discussed below with reference to FIGS. 3 through 7.

In a case where a size of an object provided between the electrodes 20 and 21 is macroscopically large, the tunneling current is simply characterized with Ohm's law. In contrast, in a case where the size of the object is quite small such as, for example, a nano-sized to meso-sized ring or molecule, a superposition state in terms of pathways of the tunneling current (current pathways) appears. Quantum interference on the current pathway is used as a superconducting quantum interference device (SQUID) in a superconducting device.

Meanwhile, in a molecular system, the superposition state is little more complicated. A superposition state of molecular “tunneling orbitals” (frontier orbitals in a state where contact positions with electrodes are specified) is an appropriate molecular theory to understand a tunneling current that is generated by the tunneling current generation unit 11. The tunneling current is recognized as quantum interference in the single molecule 22. That is, in a small-sized system, a tunneling state is an inherently quantum state including a superposition state. The quantum state can be a unit for quantum information, i.e., a quantum bit.

Here, a molecular orbital rule for quantum tunneling will be briefly described to understand a large fluctuation of conductance in several orders of magnitude as illustrated in FIG. 2. In accordance with the orbital rule, the conductance is highly correlated to in-coming and out-going positions (i.e., sites in the single molecule 22) of the tunneling electrons. A key conclusion derived from the orbital rule is that there are a constructive position to enhance the conductance and a destructive position to decrease the conductance. These positions can be simply predicted by molecular orbitals (MOs) of the single molecule 22.

The upper part of FIG. 3 is a schematic diagram illustrating a highest occupied molecular orbital (HOMO) and a lowest unoccupied molecular orbital (LUMO) of the adenine molecule. In FIG. 3, a difference in color corresponds to a difference of signs (positive/negative signs of phases in a wave function) of MO coefficients of the HOMO and LUMO.

In a case where the orbital rule is used, constructive interference in quantum tunneling occurs when a sign of a product of two HOMO coefficients at the two positions (i.e., the in-coming position and the out-going position) is different from a sign of a product to two LUMO coefficients at the two positions. Meanwhile, destructive interference in quantum tunneling occurs when the sign of the product of the two HOMO coefficients is identical to the sign of the product of the two LUMO coefficients. The orbital rule is derived directly from the Green's function of the molecule. The Green's function is represented by an expression below. In the expression, “E”, “Ei”, and “ψi” indicate energy of tunneling electron, i-th MO energy, and an i-th wave function, respectively, in the single molecule 22.

$${\sum }_{i} \frac{\vert {ψ}_{i} \text{><} \vert {ψ}_{i} \vert}{E - {E}_{i}} \qquad ( 1 )$$

In the example illustrated in the upper part of FIG. 3, a pair of “In” and “Out1” positions corresponds to the constructive interference, and a pair of “In” and “Out2” positions corresponds to the destructive interference.

The lower part of FIG. 3 is a graph indicating transmission functions Tc(E) and Td(E) calculated based on the Green's function for the constructive interference and the destructive interference, respectively. In FIG. 3, the transmission function Tc(E) for the constructive interference is indicated by the solid line, and the transmission function Td(E) for the destructive interference is indicated by the dashed dotted line. From the expression of Green's function, it is possible to understand that the two peaks of the transmission functions Tc(E) and Td(E) are originated from HOMO and LUMO.

According to the Landauer model for providing conductance related to a small object, conductance of tunneling current generated when a small bias voltage is applied between the electrodes 20 and 21 of the tunneling current generation unit 11 is proportional to the transmission function at the Fermi level of the electrodes 20 and 21. The Fermi level of the electrodes 20 and 21 is normally located at around a mid-position between HOMO and LUMO, and therefore a conductance difference between the constructive interference and the destructive interference can be quite large. Large fluctuation of conductance shown in FIG. 2 is thus recognized as a result of the constructive interference and the destructive interference.

In regard to the fluctuation of conductance shown in FIG. 2, it is possible to recognize that the highest value of conductance is originated from the constructive interference in tunneling, and the lowest value of conductance (smaller by approximately two orders of magnitude than the value for constructive interference in FIG. 2) is originated from the destructive interference in tunneling. This is because, for the conductance in the lower part of FIG. 3 (i.e., a transmission coefficient at the Fermi level), a difference of conductance between the constructive interference and the destructive interference is few orders of magnitude or greater.

Next, intermediate conductance will be considered. First, a discussion is made from a “classical” viewpoint. The conductance of the single molecule 22 between the electrodes 20 and 21 can vary due to molecular vibrations and can vary due to a large deformation of a molecular structure. However, it is known that the change in conductance due to molecular vibrations is not so large. Therefore, the discussion is made based on a large deformation of molecular structure.

Such a deformation can be one of candidates to explain the intermediate conductance. However, in such a case of deformation, several variations of deformed structures can be expected, and thus a wide range of values needs to be observed as the intermediate conductance. Meanwhile, the intermediate conductance shown in FIG. 2 is rather a definitive value. Thus, the large deformation of molecular structure is insufficient to explain the intermediate conductance.

Next, a discussion is made from a “quantum” viewpoint. In the orbital rule for tunneling, it is assumed that a single site is selected as an “In” or “Out” position. However, this assumption means that a single quantum (i.e., an electron) needs always to select a single site for entering into a single molecule or escaping from a single molecule. This is somewhat an extremely simplified assumption in quantum tunnel effect.

In FIG. 4, the upper part is a schematic diagram illustrating superposition of tunneling pathways in a single configuration of the molecule between the electrodes, and the lower part is a graph indicating a transmission function T(E) of the single configuration. In FIG. 4, the transmission function Tc(E) for the constructive interference is indicated by the solid line, the transmission function Td(E) for the destructive interference is indicated by the dashed dotted line, and the transmission function Ts(E) calculated while taking the superposition into account is indicated by the two-dot chain line.

In quantum mechanics, as illustrated in the upper part of FIG. 4, the superposition of a tunneling pathway In-Out1 and a tunneling pathway In-Out2 seems to be easily realized. Meanwhile, according to the lower part of FIG. 4, unexpectedly, the transmission function Ts(E) calculated while taking the superposition into account is almost the same as the transmission function Tc(E) of the constructive interference. Therefore, the conductance as a result of the superposition becomes conductance almost the same as that for the constructive interference, and does not become intermediate conductance.

A next quantum viewpoint to be considered is superposition of a relative configuration of the single molecule 22 with respect to the two electrodes 20 and 21. This is because a nucleus is also a quantum mechanical particle which shows tunneling between stable positions.

In FIG. 5, the upper part is a schematic diagram illustrating superposition of a plurality of configurations of the molecule between the electrodes, and the lower part is a graph indicating a transmission function T(E) of the plurality of configurations. In FIG. 5, the transmission function Tc(E) for the constructive interference is indicated by the solid line, the transmission function Td(E) for the destructive interference is indicated by the dashed dotted line, and the transmission function Ts(E) calculated while taking the superposition into account is indicated by the two-dot chain line.

In FIG. 5, the schematic diagram on the left side of the upper part is different in relative configuration of the single molecule 22 from the schematic diagram on the right side of the upper part, and the other configurations are the same. In the relative configuration on the left side of the upper part of FIG. 5, electrons of tunneling current flow along the tunneling pathway In-Out1. In the relative configuration on the right side of the upper part of FIG. 5, electrons of tunneling current flow along the tunneling pathway In-Out2.

In quantum mechanics, the superposition of the relative configuration indicated on the left side of the upper part of FIG. 5 and the relative configuration indicated on the right side of the upper part of FIG. 5 seems to be easily realized. According to the lower part of FIG. 5, the transmission function Ts(E) calculated while taking the superposition into account is located between the transmission function Tc(E) of the constructive interference and the transmission function Td(E) of the destructive interference. Therefore, the conductance as a result of the superposition becomes the intermediate conductance. Note that theoretical support for this discussion will be described later.

As a result, the following conclusion has been found. That is, high conductance data can be assigned to a constructive interference state, and low conductance data can be assigned to a destructive interference state. Intermediate conductance data can be assigned to a superposition state between the constructive interference and destructive interference by superposition of relative configurations of the single molecule 22.

The following description will discuss a manner to encode a plurality of quantum states including superposition states into a bit array. Before encoding of a superposition state, it is necessary to encode constructive (i.e., high conductance) tunneling and destructive (i.e., low conductance) tunneling as pure states in terms of binary numbers |0> and |1>. In accordance with tunneling processes shown in the upper part of FIG. 3 and the upper part of FIG. 5, three sites respectively become quantum bits, and a bit array composed of the three sites is the minimum model. Sites 1, 2, and 3 respectively correspond to sites of In, Out1, and Out2 shown in the upper part of FIG. 3 and the upper part of FIG. 5.

Here, it is assumed that an initial bit array is represented as |100>. Wherein, the first, second, and third bits indicate the site In, site Out1, and site Out2, respectively. Thus |100> indicates that a tunneling electron has entered the site In.

After electron tunneling, it is possible to consider several patterns as a bit array. For example, a tunneling process from In to Out1 can be encoded as |110>, and the tunneling process from In to Out2 can be encoded as |101>. Meanwhile, a superposition state between |110> and |101> is |110>+|101>, i.e., a quantum entanglement state.

Surprisingly, it is possible to construct a sequence (quantum circuit) of quantum gates which can produce the pure states |110> and |101>, and the superposition state|110>+|101>.

FIG. 6 is a diagram illustrating a quantum circuit constituted by a plurality of quantum gates that corresponds to the adenine molecule in the quantum computer. FIG. 7 is a diagram illustrating an example of quantum computation in the quantum circuit. As illustrated in FIG. 6 and FIG. 7, the quantum gates are constituted by unitary gates and controlled-NOT gates.

FIG. 7 illustrates outputs of quantum bit arrays in a high level conductance state, a low level conductance state, and an intermediate level conductance state in this order from the top. These three states correspond to a constructive tunneling process, a destructive tunneling process, and the superposition tunneling process, respectively. That is, the tunneling process and conductance measurement respectively correspond to operation and read-out in the quantum computer based on the quantum circuit illustrated in FIG. 6. Surprisingly, a superposition state is observed as the superposition state.

In the quantum gates shown in FIG. 6 and FIG. 7, there is a unitary gate defined with a rotation angle θ. As is easily understood from the result of FIG. 7, any weighting (real numbers) for the constructive interference and the destructive interference in the superposition state can be realized with use of the rotation angle θ. In other words, distribution of the rotation angle θ represents a signature of a quantum mechanical feature of the single molecule 22.

That is, it is possible to obtain frequency distribution of the intermediate conductance by Fourier transformation of time series data of the intermediate level conductance, and to identify distribution of the rotation angle θ based on the obtained frequency distribution.

(Effect)

As described above, the quantum computer 10 in accordance with Embodiment 1 does not require a superconducting state, a very low temperature, and the like that were necessary for known quantum computers. Consequently, quantum calculation can be easily carried out. Further, since the tunneling current generation unit 11 is operable at room temperature, the quantum computer 10 can carry out quantum calculation at room temperature.

The plurality of positions at which electrons of the tunneling current enter the single molecule 22 or escape from the single molecule 22 are used as a quantum bit array, the presence and absence of entrance correspond to 1 and 0, respectively, and the presence and absence of escape correspond to 1 and 0, respectively. In this case, it is possible to theoretically identify a quantum circuit (see FIGS. 6 and 7) constituted by a plurality of quantum gates corresponding to the single molecule 22, based on a structure of the single molecule 22, the molecular orbital, and the molecular orbital rule.

Note that, with reference to FIG. 6 and FIG. 7, a quantum bit at the site In can be considered to correspond to the presence or absence of a voltage for passing a tunneling current. It can also be considered that a quantum bit of the site Out1 corresponds to whether conductance is at a high level or not, and a quantum bit of the site Out2 corresponds to whether conductance is at a low level or not. Therefore, a plurality of current levels relating to a tunneling current, or a plurality of conductance levels corresponding to the plurality of current levels can be used as a quantum bit array.

The quantum encoder 16 outputs the distribution of rotation angle θ and the quantum bit array. Therefore, depending on a value of conductance measured by the conductance measurement unit 15, it is possible to encode a superposition state of the plurality of quantum bits. Note that, when the voltage is a predetermined value, it is possible to replace the conductance value with the value of the tunneling current.

(Additional Remarks)

In the above discussion, the state of the single molecule 22 between the electrodes 20 and 21 is a loosely bound state, that is, a state in which a minute movement is accepted. Note, however, that the state of the single molecule 22 is not limited to this. For example, the state of the single molecule 22 can be in a state of strong bonding with electrodes, i.e., a state of a so-called single molecular junction in which both sides of the single molecule 22 are respectively connected to the two electrodes 20 and 21.

The molecule located between the electrodes 20 and 21 can be a plurality of molecules, or can be the whole or a part of the single molecule 22, provided that a candidate (or candidates) of sites (quantum bits) at which electrons of a tunneling current enter or escape can be identified, or provided that the intermediate level conductance appears. The tunneling current generation unit 11 can include three or more electrodes.

The number of sites (quantum bits) at which electrons of tunneling current enter is one, and the number of sites (quantum bits) at which the electrons escape is two. Note, however, that such numbers of sites (quantum bits) are not limited to this example. The number of in-coming sites and the number of out-going sites depend on a structure and a molecular orbital of the single molecule 22.

In Embodiment 1, a gate system is employed. Meanwhile, it is said that, theoretically, an annealing system can carry out a process equivalent to that by the quantum gate system. Therefore, it is expected that Embodiment 1 can be realized also by the annealing system.

### Embodiment 2

The following description will discuss another embodiment of the present invention with reference to FIG. 8.

FIG. 8 is a block diagram illustrating a schematic configuration of a quantum entanglement detection device in accordance with Embodiment 2. A quantum entanglement detection device 30 illustrated in FIG. 8 detects whether or not quantum entanglement between quantum bits is occurring in the single molecule 22 through which a tunneling current flows. The quantum entanglement detection device 30 illustrated in FIG. 8 is different from the quantum computer 10 illustrated in FIG. 1 in that a quantum entanglement detection unit 31 (determination unit) is provided instead of the quantum encoder 16, and the other configurations are the same.

As described above, intermediate level conductance data can be assigned to a superposition state between the constructive interference and destructive interference by superposition of relative configurations of the single molecule 22. Therefore, the quantum entanglement detection unit 31 determines, based on the measurement data from the conductance measurement unit 15, that quantum entanglement between the quantum bit Out1 and the quantum bit Out2 is occurring, in a case where the measured value of conductance is the intermediate level conductance illustrated in FIG. 2.

According to the configuration, a quantum entanglement state can be detected without breaking the quantum entanglement.

### Embodiment 3

The following description will discuss another embodiment of the present invention with reference to FIG. 9.

FIG. 9 is a block diagram illustrating a schematic configuration of a single molecule sequencer in accordance with Embodiment 3. The single molecule sequencer 40 (molecule identification device) illustrated in FIG. 9 identifies a single molecule 22 by measuring a tunneling current flowing through the single molecule 22. The single molecule sequencer 40 illustrated in FIG. 9 has a configuration obtained by adding, to the quantum computer 10 illustrated in FIG. 1, a quantum gate preparation unit 41, a quantum gate storage unit 42 (storage unit), a quantum calculation unit 43 (another quantum circuit), and a molecule identification unit 44 (identification unit).

The quantum gate preparation unit 41 prepares quantum gates corresponding to a known single molecule 22. The quantum gate preparation unit 41 stores the prepared quantum gate information in the quantum gate storage unit 42.

Specifically, the quantum gate preparation unit 41 prepares in advance quantum gates as illustrated in, for example, FIG. 6 on the basis of a molecular structure, a molecular orbital, and an orbital rule of the known single molecule 22. Next, the quantum gate preparation unit 41 obtains time series data of the intermediate level conductance for the known single molecule 22 from the conductance measurement unit 15, and uses the time series data to identify distribution of rotation angle θ of a unitary gate U(θ) included in the quantum gates.

Then, the quantum gate preparation unit 41 stores the information of the prepared quantum gates and the information of the distribution of rotation angle θ in the quantum gate storage unit 42 together with identification information of the known single molecule 22. The quantum gate preparation unit 41 repeats the above operation for a plurality of single molecules 22. Note that, in a case where the quantum gate storage unit 42 stores in advance quantum gates and distribution of rotation angle θ for a plurality of single molecules, it is possible to omit the quantum gate preparation unit 41.

The quantum gate storage unit 42 stores, for each of the plurality of single molecules 22, information of quantum gates and information of distribution of rotation angle θ of that single molecule 22 together with identification information of that single molecule 22. The identification information of the single molecule 22 can be a name or an abbreviation of the single molecule 22.

The quantum calculation unit 43 carries out, with respect to a quantum bit array from the quantum encoder 16, quantum calculation based on quantum gates read out from the quantum gate storage unit 42. The quantum calculation unit 43 sends a result of the calculation to the molecule identification unit 44. Note that, as the quantum calculation unit 43, it is possible to employ an existing quantum computer, or to employ the quantum computer using the single molecule 22 as illustrated in FIG. 1.

Specifically, first, for an unknown single molecule 22, the quantum computer 10 is operated, and a quantum bit array encoded by the quantum encoder 16 is sent to the quantum calculation unit 43. Next, the quantum calculation unit 43 (i) reads out quantum gates and distribution of rotation angle θ of a certain known single molecule 22 from the quantum gate storage unit 42, (ii) replaces the distribution of rotation angle θ with distribution of rotation angle −θ, and (iii) inputs the quantum bit array for the unknown single molecule 22 from the right side of the quantum gates to carry out quantum calculation. The quantum calculation unit 43 sends the calculated quantum bit array to the molecule identification unit 44. Then, the quantum calculation unit 43 repeats the above operation for a plurality of single molecules 22 stored in the quantum gate storage unit 42.

The molecule identification unit 44 identifies an unknown single molecule 22. Specifically, the molecule identification unit 44 determines whether or not a probability that a quantum bit array subjected to quantum calculation by the quantum calculation unit 43 for a certain known single molecule 22 conforms to an initial-state quantum bit array (in the example of FIG. 6, the quantum bit array |100> on the left) is a predetermined value or greater. In a case where the probability is equal to or greater than the predetermined value, the molecule identification unit 44 identifies the unknown single molecule 22 as the known single molecule 22, and provides notification of the identification result to the outside. Meanwhile, in a case where the probability is less the predetermined value or zero, the molecule identification unit 44 repeats the operation for another known single molecule 22.

Therefore, it is possible to identify an unknown molecule or a part of the unknown molecule by carrying out quantum calculation with respect to a quantum bit array encoded for the unknown molecule 22 provided between the electrodes 20 and 21 on the basis of a plurality of quantum gates for the known molecule. Since quantum calculation can be carried out extremely quickly, an unknown molecule or a part of the unknown molecule can be quickly identified.

(Additional Remarks)

Note that the predetermined value of the above probability can be a value common to a plurality of known single molecules 22, or can be individual values. In a case where the predetermined value of the probability is each of individual values, the following operation can be carried out.

That is, the quantum computer 10 operates for a certain known single molecule 22, and outputs a quantum bit array. Next, the quantum calculation unit 43 (i) reads out quantum gates and distribution of rotation angle θ of the certain known single molecule 22 from the quantum gate storage unit 42, (ii) replaces the distribution of rotation angle θ with distribution of rotation angle −θ, and (iii) inputs the quantum bit array from the right side of the quantum gates to carry out quantum calculation. Next, the molecule identification unit 44 determines whether or not a quantum bit array subjected to the quantum calculation conforms to the initial-state quantum bit array.

Then, the molecule identification unit 44 repeats the above operation and calculates the probability of conformity, and stores the calculated value as the predetermined value in the quantum gate storage unit 42 together with quantum gates and distribution of rotation angle θ of the certain known single molecule 22. Then, the above operation is repeated for the other known single molecules 22. Thus, it is possible to store, in the quantum gate storage unit 42, the predetermined values corresponding to the plurality of known single molecules 22.

The single molecule sequencer 40 in accordance with Embodiment 3 is also applicable to DNAs. Specifically, it is possible that the single molecule sequencer 40 causes a DNA to pass between the electrodes 20 and 21 and supplies a tunneling current during the passage to identify a base in the passage, and repeats this operation to identify a base sequence.

(Theoretical Support)

Lastly, the following describes the theoretical support for the foregoing discussion, with reference to FIG. 10.

FIG. 10 is a diagram for explaining the theoretical support. The upper part of FIG. 10 is a chemical formula of an adenine molecule with atom indices. The middle part of FIG. 10 is a schematic diagram of single molecule confinement (SMC). The lower part of FIG. 10 is a table indicating correspondence between connection positions of the single molecule and an electrode and calculated values of total energies in an example of the SMC. The example in FIG. 10 is similar to the examples illustrated in the upper parts of FIG. 4 and FIG. 5, and adenine, which is a single molecule, is sandwiched and confined between two electrodes constituted by Au. A distance between the two electrodes is 8 Å.

### (1) GREEN'S FUNCTION METHOD FOR CONDUCTANCE

In this section, a non-equilibrium Green's function method for conductance of a molecular-contact is introduced (Reference Document 1). A schematic of a molecular contact in which the single molecule is sandwiched between the left electrode and the right electrode is shown in the middle part of FIG. 10. As the first step, a case is considered in which a single molecule interacts with the right electrode only, and a result of a one-electrode model is applied to a two-electrode model. A system of one electrode (i.e., the right electrode) can be represented with a tight-binding Hamiltonian, and therefore the Green's function for the system can be represented by the following equation.

$$\begin{matrix}G ( E ) = {( ( E + i {0}^{+} ) I - H )}^{- 1} \\ = {( \begin{matrix}( E + i {0}^{+} ) I - {H}_{M} & - {H}_{int} \\ - {H}_{int} & ( E + i {0}^{+} ) I - {H}_{R}\end{matrix} )}^{- 1}\end{matrix} \qquad ( 2 )$$

In the equation, “H_{M}” and “H_{R}” are respectively Hamiltonian matrices of the single molecule and the right electrode. “Hᵢₙₜ” is a matrix representing interaction W between the single molecule and the right electrode (see the middle part of FIG. 10). “I” is a unit matrix and “0⁺” is a small number (which is infinitesimal and causes no influence on physical phenomena) with the positive sign. When the single molecule is adenine, a Hamiltonian matrix of an adenine isolated molecule can be used as the H_{M}. With use of the equation (2), it is possible to obtain the Green's function of the single molecule part as in the following equation in which the interaction with the electrode is renormalized.

G_{M}(E)=(EI−H_{M}−Σ_{R}(E))⁻¹ (3)

Here, self-energy Σ_{R}(E) of the right electrode is represented by the following equation.

Σ_{R}(E)=Hᵢₙₜ((E+i0⁺)I−H_{R})⁻¹Hᵢₙₜ⁺ (4)

The term ((E+i0⁺)I−H_{R})⁻¹ is the Green's function of the right electrode, and the Green's function can be easily calculated from atom position information (structure information) in the electrode. For example, the middle part of FIG. 10 illustrates an example related to a one-dimensional electrode. In this case, the Green's function can be represented by an analytical equation (Reference Document 2), and the self-energy can be directly obtained. It is recognized that influence by the right electrode can be introduced via the self-energy to the Green's function of the single molecule as shown in the equation (3). From this, it is possible to apply the result of the one electrode model to the two electrodes as represented by the following equation.

G_{M}(E)=(EI−H_{M}−Σ_{R}(E)−E_{L}(E))⁻¹ (5)

In the equation, Σ_{L}(E) is self-energy of the left electrode (i.e., a second electrode). With use of the Green's function G_{M}(E) of the molecule and the self-energy of the two electrodes, the transmission function T can be represented as in the following equation. In the following equation, Tr[A] is a trace of a matrix A.

T(E)=Tr[i{Σ_{L}(E)−Σ_{L}⁺(E)}G_{M}(E)i{Σ_{R}(E)−Σ_{R}⁺(E)}G_{M}⁺] (6)

### (2) THEORETICAL BACKGROUND FOR CONTRACTION-FREE OBSERVATION OF QUANTUM STATES

In this section, provided is a theoretical foundation for contraction-free observation of quantum states. The explanation will be made in the following two steps. The explanation in the step (i) relates to how a superposition state including molecular states such as HOMO and LUMO (see FIG. 3) can be preserved (i.e., observed) during tunneling current measurements. In the step (ii), formulation for a superposition state between molecular configurations is extended, and how the transmission function T is modified in the configuration superposition is explained.

The explanations in the step (i) basically follow the theoretical foundation for tunneling current given by Emberly and Kirczenow (Reference Document 2). A normalized wave function Ψ of the system shown in the middle part of FIG. 10 can be represented as the following equation.

$$\vert Ψ 〉 = {{\sum }_{n = - ∞}}^{- 1} {ψ}_{n} \vert n 〉 + {{\sum }_{n = 1}}^{∞} {ψ}_{n} \vert n 〉 + {\sum }_{j} {c}_{j} \vert {ϕ}_{j} 〉 \qquad ( 7 )$$

In the equation, “|n>(n=−∞, . . . , −1, 1, . . . , □)” is an orthonormal basis for a plurality of electrodes, and “φⱼ (j=1, 2, . . . )” is a molecular orbital of the sandwiched molecule. Here, “n” is a serial numbers of atoms constituting the electrode (1 orbital/1 atomic model is employed). The expansion coefficients ψₙ and cⱼ are determined depending on interactions W between the sandwiched molecule and the plurality of electrodes. Lippmann-Schwinger (LS) equation is useful to understand how the wave function Ψ is modified by the interactions.

The following description will assume a case where electrons are injected from the left electrode and transmitted to the right-hand side. If there are no interactions between the left electrode and the rest (i.e., the molecule and right electrode), the electron is represented with an eigenstate |Φ₀>(=Σ_{n=-∞}⁻¹(ϕ₀)ₙ|n [symbol] ) of the left electrode.

In contrast, when the interactions happen, the wave function is represented as in the following equation with use of the LS equation.

|Ψ [symbol] =|Φ₀ [symbol] +G₀W|Ψ [symbol] (8)

In the equation, “G₀” is a Green's function for a system in which the left electrode and the right electrode are decoupled from the molecule, that is, a Green's function in a state in which the molecule is isolated. With use of the equation (7) and the equation (8), the following equation is obtained.

$$\vert Ψ 〉 = {{\sum }_{n = - ∞}}^{- 1} {( {ϕ}_{0} )}_{n} \vert n 〉 + ( {{\sum }_{n , m = - ∞}}^{- 1} {( {G}_{0}^{L} )}_{n , m} \vert n 〉 〈 m \vert + {{\sum }_{n , m = 1}}^{∞} {( {G}_{0}^{R} )}_{n , m} \vert n 〉 〈 m \vert + {\sum }_{j} {( {G}_{0}^{M} )}_{j} \vert {ϕ}_{j} 〉 〈 {ϕ}_{j} \vert ) \times W \times ( {{\sum }_{n = - ∞}}^{- 1} {ψ}_{n} \vert n 〉 + {{\sum }_{n = 1}}^{∞} {ψ}_{n} \vert n 〉 + {\sum }_{j} {c}_{j} \vert {ϕ}_{j} 〉 ) \qquad ( 9 )$$

When the electron is observed at an apex of the left electrode, the wave function Ψ is projected onto the base |−1> as in the following equation.

$$〈 - 1 \vert Ψ 〉 = {( {ϕ}_{0} )}_{- 1} + {( {G}_{0}^{L} )}_{- 1 , - 1} ( {\sum }_{j} {c}_{j} 〈 - 1 \vert W \vert {ϕ}_{j} 〉 ) \qquad ( 10 )$$

Note that, in regard to the equation (10), used is a fact that integrals related to W can be non-zero only for <−1|W|φⱼ> and <1|W|φⱼ. This is because W is the interactions between the left and right electrodes and the molecule. When there are no interactions between the left electrode and the molecule, <−1|Ψ>=(φ₀)₋₁ is obtained, which is a standard contraction from |Ψ> to |−1>.

Similarly, it is possible to consider a case where the electron is observed at the apex of the right electrode (i.e., transmitted), as in the following equation.

$$〈 1 \vert Ψ 〉 = {( {G}_{0}^{R} )}_{1 , 1} ( {\sum }_{j} {c}_{j} 〈 1 \vert W \vert {ϕ}_{j} 〉 ) \qquad ( 11 )$$

The transmission function is calculated as |<1|Ψ>|². If there are no interactions between the right electrode and the molecule, the equation (11) reads <1|Ψf>=0, which indicates that tunneling of electrons from the left electrode to the right electrode is zero.

An important conclusion which is clearly understood based on the equation (11) is that the superposition of molecular eigenstates can be preserved (i.e., no-contraction) even after the observation of tunneling electron by the right electrode. The coefficients cⱼ can be represented with use of the molecular Green's function G₀^{M} (Reference Document 2). The expansion of molecular orbitals in terms of atomic orbitals and application of HOMO-LUMO approximation in the Green's function lead to the molecular conduction orbital rule for tunneling (Reference Document 3). By this rule, when electron tunneling occurs on the molecule, superposition of HOMO and LUMO of the molecule results in constructive and destructive quantum interferences, which are experimentally confirmed as a large difference in conductivity (Reference Document 4).

Next, the following description will discuss the step (ii). Here, considered are two molecular configurations A and B, which are relatively different with respect to the two electrodes. When the molecule takes a single configuration (i.e., A or B), a normalized wave function of the configuration A is written as in the following equation.

$$\vert {Ψ}^{A} 〉 = {{\sum }_{n = - ∞}}^{- 1} {ψ}_{n} \vert n 〉 + {{\sum }_{n = 1}}^{∞} {ψ}_{n} \vert n 〉 + {\sum }_{j} {c}_{j}^{A} \vert {ϕ}_{j}^{A} 〉 \qquad ( 12 )$$

Moreover, a normalized wave function of the configuration B is written as in the following equation.

$$\vert {Ψ}^{B} 〉 = {{\sum }_{n = - ∞}}^{- 1} {ψ}_{n} \vert n 〉 + {{\sum }_{n = 1}}^{∞} {ψ}_{n} \vert n 〉 + {\sum }_{j} {c}_{j}^{B} \vert {ϕ}_{j}^{B} 〉 \qquad ( 13 )$$

The following assumes that an amount of charge transfer between the molecule and the plurality of electrodes is the same in the two configurations. In fact, this is a reasonable condition for SMC. In this case, a relation of Σⱼ|cⱼ^{A}|²=Σⱼ|cⱼ^{B}|² is satisfied, and thereby the normalized wave function for the superposition between the configuration A and the configuration B can be written as in the following equation.

$$\vert {Ψ}^{A + B} 〉 = {{\sum }_{n = - ∞}}^{- 1} {ψ}_{n} \vert n 〉 + {{\sum }_{n = 1}}^{∞} {ψ}_{n} \vert n 〉 + \frac{1}{√ 2} {\sum }_{j} {c}_{j}^{A} \vert {ϕ}_{j}^{A} 〉 + \frac{1}{√ 2} {\sum }_{j} {c}_{j}^{B} \vert {ϕ}_{j}^{B} 〉 \qquad ( 14 )$$

Here, a relation <φⱼ^{N}|φₖ^{M}>=δ_{NM}δⱼₖ is used. With use of the equation (14) and the LS equation (the equation (8)), the wave function with the configuration superposition is rewritten as in the following equation.

$$\vert {Ψ}^{A + B} 〉 = {{\sum }_{n = - ∞}}^{- 1} {( {ϕ}_{0} )}_{n} \vert n 〉 + ( {{\sum }_{n , m = - ∞}}^{- 1} {( {G}_{0}^{L} )}_{n , m} \vert n 〉 〈 m \vert + {{\sum }_{n , m = 1}}^{∞} {( {G}_{0}^{R} )}_{n , m} \vert n 〉 〈 m \vert + {\sum }_{M = A , B} {\sum }_{j} {( {G}_{0}^{M} )}_{j} \vert {ϕ}_{j}^{M} 〉 〈 {ϕ}_{j}^{M} \vert ) \times W \times ( {{\sum }_{n = - ∞}}^{- 1} {ψ}_{n} \vert n 〉 {{\sum }_{n = 1}}^{∞} + \frac{1}{√ 2} {\sum }_{j} {c}_{j}^{A} \vert {ϕ}_{j}^{A} 〉 + \frac{1}{√ 2} {\sum }_{j} {c}_{j}^{B} \vert {ϕ}_{j}^{B} 〉 ) \qquad ( 15 )$$

Therefore, the observation of the tunneling electron at the right electrode reads the following equation.

$$〈 1 \vert {Ψ}^{A + B} 〉 = \frac{1}{√ 2} {( {G}_{0}^{R} )}_{1 , 1} ( {\sum }_{j} {c}_{j}^{A} 〈 1 \vert W \vert {ϕ}_{j}^{A} 〉 + {\sum }_{j} {c}_{j}^{B} 〈 1 \vert W \vert {ϕ}_{j}^{B} 〉 ) \qquad ( 16 )$$

Thus, obtained is the conclusion that the measurements of tunneling electron with the right electrode break neither the superposition state between different molecular configurations, nor the superposition state between molecular eigenstates in each configuration. This is the theoretical foundation of the contraction-free quantum state observation.

Finally, provided is a transmission function for the superposition state. The transmission function T^{A(B)} of a single configuration (i.e., A or B) is written as in the following equation.

$${T}^{A ( B )} = \vert 〈 1 \vert {Ψ}^{A ( B )} 〉 {\vert}^{2} = \vert {( {G}_{0}^{R} )}_{1 , 1} ( {\sum }_{j} {c}_{j}^{A ( B )} 〈 1 \vert W \vert {ϕ}_{j}^{A ( B )} 〉 ) {\vert}^{2} \qquad ( 17 )$$

The transmission function of the superposition state between the configuration A and the configuration B is as in the following equation.

$${T}^{A + B} = \vert 〈 1 \vert {Ψ}^{A + B} 〉 {\vert}^{2} ≅ \frac{1}{2} ( {T}^{A} + {T}^{B} ) . \qquad ( 18 )$$

In the last transformation, a contribution from a cross term of (T^{A})^{1/2}(T^{B})^{1/2} is omitted. This is because, when the configuration A or the configuration B (or both) corresponds to destructive interference, the term is a negligibly small number. The equation (18) corresponds to a simple average between T^{A} and T^{B}. This result is originated from the same weight of the configurations A and B in the equation (14), and said same weight corresponds to θ=45° in the unitary operation of the quantum state of the sandwiched molecule.

### (3) CALCULATION RESULT OF TOTAL ENERGIES

Configurations of the single molecule and calculated values of total energies in the respective configurations are indicated in the lower part of FIG. 10. In the lower part of FIG. 10, for example, “Au—[N(6);N(3)]-Au” means a configuration in which an electron is transmitted from the left electrode to the right electrode via the N atom with the index 6 and the N atom with the index 3 in adenine. The unit of the total energies is hartree. From the calculation result of the total energies, it is possible to understand that the configuration “Au—[N(6);N(3)]—Au” and the configuration “Au—[N(6);C(1)]—Au” appear with almost the same probability, and the configurations respectively correspond to the constructive interference and the destructive interference (see FIG. 4).

### (4) REFERENCE DOCUMENTS

1. S. Datta, Electronic Transport in Mesoscopic Systems, Cambridge University Press, Cambridge, 1995.
2. E. G. Emberly and G. Kirczenow, Antiresonances in molecular wires, J. Phys.:Condens. Matter, 11, 6911 (1999).
3. T. Tada and K. Yoshizawa, Quantum Transport Effects in Nanosized Graphite Sheets. ChemPhysChem 3, 1035 (2002).
4. Y. Li, M. Buerkle, G. Li, A. Rostamian, H. Wang, Z. Wang, D. R. Bowler, T. Miyazaki, L. Xiang, Y. Asai, G. Zhou, and N. Tao, Gate controlling of quantum interference and direct observation of anti-resonances in single molecule charge transport. Nat. Mater. 18, 357 (2019).

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

10: Quantum computer
11: Tunneling current generation unit
12: Power source
13: Current sensor (detection unit)
14: Voltage sensor
15: Conductance measurement unit
16: Quantum encoder (encoder)
20, 21: Electrode
22: Single molecule
30: Quantum entanglement detection device
31: Quantum entanglement detection unit (determination unit)
40: Single molecule sequencer (molecule identification device)
41: Quantum gate preparation unit
42: Quantum gate storage unit (storage unit)
43: Quantum calculation unit (another quantum circuit)
44: Molecule identification unit (identification unit)

1-6. (canceled)

7. A method for controlling a quantum computer in which a molecule is entirely or partially provided between a plurality of electrodes and the molecule works as a quantum circuit for carrying out quantum calculation, said method comprising the steps of:
detecting a tunneling current which flows between the plurality of electrodes via the molecule; and
encoding into a quantum bit array based on time series data of the tunneling current.

8. A method for detecting quantum entanglement, said method comprising the steps of:
detecting a tunneling current which flows between a plurality of electrodes via a molecule or a part of the molecule provided between the plurality of electrodes; and
determining that a quantum entanglement state is occurring, in a case where a conductance value based on the tunneling current is at an intermediate level between a high level and a low level.

9. A method for identifying a molecule or a part of the molecule provided between a plurality of electrodes, said method comprising the steps of:
detecting a tunneling current which flows between the plurality of electrodes via the molecule or the part of the molecule which works as a quantum circuit having a plurality of quantum gates;
encoding time series data of the tunneling current into a quantum bit array;
carrying out quantum calculation with respect to the quantum bit array based on the plurality of quantum gates which have been read out from a storage unit storing information of the plurality of quantum gates for each of a plurality of known molecules; and
identifying the molecule or the part of the molecule based on a result of the quantum calculation.

10. The method as set forth in claim 7, wherein a plurality of positions at which electrons of the tunneling current enter the molecule or escape from the molecule are used as a quantum bit array.

11. The method as set forth in claim 7, wherein a plurality of current levels related to the tunneling current are used as a quantum bit array.

12. The method as set forth in claim 7, further comprising an encoder that encodes, based on the quantum circuit, time series data of the tunneling current into a quantum bit array.
